(19) United States
(12) Patent Application Publication
(10) Pub. No.: US 2026/0327119 A1
(43) Pub. Date: Oct. 22, 2026

(54) COMBINATION FAUCET PROTECTOR AND WATER PURIFYING DEVICE

(71) Applicant: WAVVY BRANDS LLC, New York, NY (US)

(72) Inventor: Warren M. Davis, Brooklyn, NY (US)

(73) Assignee: WAVVY BRANDS LLC, New York, NY (US)

(21) Appl. No.: 19/264,190

(22) Filed: Jul. 9, 2025

Related U.S. Application Data
(60) Provisional application No. 63/791,831, filed on Apr. 21, 2025.

(51) Int. Cl. C02F 9/20

(52) U.S. Cl. CPC C02F 9/20; C02F 2201/006; C02F 2203/006; C02F 2307/06

(57) ABSTRACT

Disclosed herein are faucet-mounted water filtration and safety apparatus comprising an elastomeric main body, a downward-extending filtration housing connected to the elastomeric main body, optionally removably connected, and a water filtration cartridge. Also disclosed herein are methods of using such apparatuses to generate filtered water for, for example, bathing.

This application claims the benefit of U.S. Provisional Patent Application No. 63/791,831, filed Apr. 21, 2025, which is incorporated by reference herein in its entirety.

### FIELD OF THE INVENTION

The present invention relates to water filtration and safety systems for residential plumbing fixtures. More specifically, it pertains to a combined filtration and protective device configured to be mounted on a bathtub or sink faucet spout. The invention integrates a child-safe, elastomeric spout cover with a filtration housing to provide impact protection and/or water treatment functionality during bathing.

### BACKGROUND

Faucet-mounted safety covers for bathtubs are commonly used to protect infants and children from impact injuries during bathing by providing a soft, resilient barrier over protruding metallic spouts. Separately, concerns regarding water quality in domestic bathing environments have increased, as bath water may contain chlorine, heavy metals, and other contaminants that can irritate sensitive skin or pose health risks, for example, if ingested.

While certain point-of-use water filtration devices exist, these systems are typically designed for shower or sink fixtures and are structurally incompatible with conventional bathtub spouts. Standard bathtub spouts are generally unthreaded, wall-mounted, and lack the inline or axial fittings required by most existing filter systems, rendering shower-type filtration products unsuitable for bathtub faucet applications.

To date, no known solution has been developed that employs an easy-to-connect, sleeve-like cover attachable to a household faucet or waterspout to enable water filtration. Furthermore, no commercially available system combines water filtration with the physical safety features of a spout cover in a unified form factor designed specifically for bathtub or sink use.

### SUMMARY

This invention combines the protective qualities of a soft, impact-absorbing elastomeric bathtub faucet cover with an integrated water filtration unit. The apparatus is designed to fit securely over a standard bath or sink faucet, cushioning against impact and thermal injury while concurrently filtering the water as it is dispensed.

The apparatus integrates a water filtration cartridge within a downward-extending housing beneath the main body cover. As water exits the spout, it is fed through a filtration medium contained in a replaceable water filtration cartridge.

### BRIEF DESCRIPTION OF THE DRAWINGS

FIG. 1 is an isometric view of the assembled faucet-mounted safety and filtration device installed on a standard bathtub spout.

FIG. 2 is an exploded perspective view of the device, illustrating the main elastomeric spout cover, removable filter housing, and replaceable filter cartridge.

FIG. 3 is a cross-sectional side view of the device in the assembled state, showing the internal flow path from the faucet spout through the filter cartridge to the outlet.

FIG. 4 is a detailed view of the snap-fit interface between the filter housing and the main body, illustrating the circumferential bead and corresponding retention grooves.

FIG. 5 is a detailed view of the compression arms that radially extend into the main body.

FIG. 6 is a detailed view of the water filtration cartridge.

### DETAILED DESCRIPTION

Faucet-mounted safety covers for bathtub faucets are often used as a protective covering for bathing, especially bathing children or infants. Separately, water filtration devices for showers are available to remove water contaminants but are added inline to shower heads; and water devices for filtrations can be used in lower pressure sinks or can use gravity-filtering methods. However, these devices require multiple steps and tools to install, sometimes including removing a current fixture, or are incompatible for use with higher-pressure water that is often found in a bathtub faucet.

Disclosed herein are water filtration and safety apparatuses, and methods of making and using the same, that have been designed to 1) easily attach to and detach from a variety of faucets, 2) to protect people, particularly infants and children who are taking a bath, from impacting the faucet or from burning themselves on a hot faucet and 3) accommodate high pressure water flow rates. The technical features of the disclosed apparatuses include specific geometries and designs to accommodate high water flow rates, a variety of faucet types, and, in some embodiments, easy, tool-free installation.

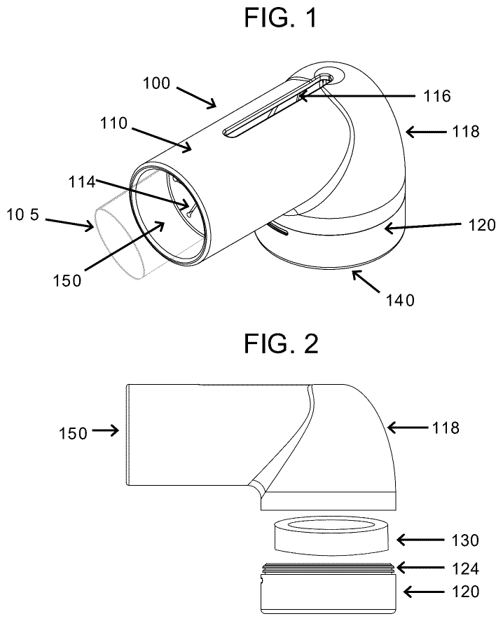

As illustrated in FIG. 1, the faucet-mounted water filtration and safety apparatus comprises a main body (110), a downward-extending filtration housing (120) positioned downstream of a fluid inlet (150), and water filtration cartridge (130) (FIG. 2) disposed withing the filtration housing (120). The faucet may be a bathtub faucet but could also be a sink faucet, such as when bathing an infant in a sink.

In some embodiments, the main body (110) is configured to fit over a faucet or spout (105). For example, the main body (110) may be dimensioned to receive and conform to the outer profile of a faucet spout (105). The length of the main body (110) should be long enough to provide a secure fit on the faucet or spout (105), but not too long such that it is difficult to attach to the faucet. For example, in some embodiments, the main body (110) has a length of about 4 inches to about 8 inches. For example, in some embodiments, the main body (110) has a length from about 5 inches to about 7 inches, from about 4 inches to about 6 inches, from about 6 inches to about 8 inches, or from about 6 inches to about 7 inches. In some embodiments, the main body (110) is from about 6 inches to about 7 inches. In some embodiments, the main body (110) has a length that is about or in any range between about 4, 5, 6, 7, and 8 inches. The fluid inlet (150) has a diameter that is large enough to provide a secure fit on the faucet or spout (105), but not large enough such that the apparatus disengages from the faucet or spout (105) when water is flowing. For example, in some embodiments, the fluid inlet (150) has a diameter from about 70 mm to about 110 mm (e.g., from about 70 mm to about 100 mm, from about 80 mm to about 110 mm, and from about 80 mm to about 100 mm). In some embodiments, the fluid inlet (150) has a diameter of about 90 mm. In some embodiments, the fluid inlet (150) has a diameter that is about or is any range between about 70, 75, 80, 85, 90, 95, 100, 105, and 110 mm.

In some embodiments, the main body (110) is configured to be a press-fit attachment for the faucet or spout (105). A press-fit attachment can be a mechanical joining where two parts are held together by friction created when one component is slightly larger than the hole or slot into which it is inserted. The parts are assembled by pressing them together, often with force, without the need for adhesives, fasteners, or welding. In such an attachment, the main body (110) has an internal diameter that is larger than the external diameter of the faucet or spout (105).

In some cases, the main body (110) is constructed from an elastomeric material. The elastomeric material may be flexible, which can facilitate a user fitting the main body over a faucet of any shape. Exemplary elastomeric materials include, but are not limited to, silicone, thermoplastic elastomer (TPE), ethylene-vinyl acetate (EVA), thermoplastic polyurethane (TPU), low-density polyethylene (LDPE), natural rubber (e.g., natural rubber latex), or any combination thereof. In some embodiments, the elastomeric material is silicone. Other types of elastomeric materials that are configured to fit over a faucet have a high tensile elongation measurement. For example, an elastomeric material used to form at least a portion of the main body of the apparatus can have a tensile elongation of at least about 125%, as measured under the ASTM D412 standard (e.g., at least about 130%, 140%, 150%, 160%, 170%, 180%, 190%, 200%, or higher). In other embodiments, an elastomeric material used to form at least a portion of the main body of the apparatus can have a tensile elongation of greater than about 100% and less than about 200%. In some embodiments, an elastomeric material used to form at least a portion of the main body of the apparatus can have a tensile elongation that is about or in any range between 100%, 105%, 110%, 115%, 120%, 125%, 130%, 135%, 140%, 145%, 150%, 155%, 160%, 165%, 170%, 175%, 180%, 185%, 190%, 195%, and 200%. In another embodiment, an elastomeric material used to form at least a portion of the main body of the apparatus can have a Shore A hardness between about 45 and about 90 (e.g., between about 45 and about 70, between about 55 and about 80, or between about 65 and about 90). In some embodiments, an elastomeric material used to form at least a portion of the main body of the apparatus can have a Shore A hardness that is about or in any range between 45, 50, 55, 60, 65, 70, 75, 80, 85, and 90. Methods for determining the hardness of elastomers, rubber, and plastics test the indentation hardness of the material. Scores range from 0 Shore to 100 Shore. Shore A hardness can be tested for using a durometer, for example, as described in ATSM D2240 and/or ISO 48-4; or by determining the indentation depth as described in ISO 868.

The elastomeric material of the main body (110) can also have other beneficial features, particularly for use with babies and small children. For example, the elastomeric material can be non-toxic and/or optimized for flexibility, durability, and/or thermal resistance, or any combination thereof. One way to modify the features of the elastomeric material is to include additives in the elastomeric material to optimize for heat resistance, antimicrobial properties, and/or enhanced durability.

In some embodiments, the main body (110) can also include a securing component for securing the main body (110) to the faucet or spout (105). For example, securing component for securing the main body (110) to the faucet can include gripping features internal to the main body (110), also referred to as internal retention features, such as ribs or ridges, compression arms (114), or a combination thereof, or external features, such as straps to attach to the faucet, wall, or a diverter valve. In some embodiments, the ribs are circumferential ribs. In other embodiments, the compression arms (114) are radially extending compression arms (114). In some embodiments, the securing component for securing the main body (110) to the faucet (105) is a combination of circumferential ribs and radially extending compression arms (114).

In some embodiments, an aperture (116) is arranged on the surface (e.g., a top surface) of the main body (110) and is configured to accommodate a diverter valve if present. The elastomeric material of the main body (110) into which the diverter valve aperture (116) is formed can stretch to fit over a diverter valve on a diverter-equipped faucet or spout. The diverter valve aperture (116) can be any shape to accommodate a diverter valve. By way of example, an aperture can be a circle, an oval, a rectangle, a slit (e.g., an elliptical slit), or a slot. While elongated diverter valve apertures (116), such as a slot, may accommodate a greater variety of locations and/or types of diverter valves, the diverter valve aperture (116) may also be tailored to fit a certain location and/or type of diverter valve.

In some embodiments, the main body (110) also includes an elongated housing interface (118) configured to receive a downward-extending filtration housing (120). In some embodiments, the elongated housing interface (118) is configured to receive a downward-extending filtration housing (120) via an upward axial insertion. In some embodiments, the main body (110) and the elongated housing interface (118) are constructed from the same elastomeric material. In another embodiment, the main body (110) and the elongated housing interface (118) are constructed from different elastomeric materials. For example, in some embodiments, the elongated housing interface (118) may be more or less flexible than the main body (110). In some embodiments, the elongated housing interface (118) may be less flexible than the main body (110) to tightly connect to the downward-extending filtration housing (120).

In some embodiments, the longitudinal axis of the elongated housing interface (118) is substantially perpendicular to the longitudinal axis of the main body (110). Alternatively, the angle between a longitudinal axis of the main body (110) and a longitudinal axis of the elongated housing interface (118) can be at an angle from about 75 degrees to about 105 degrees. In some embodiments, the angle between a longitudinal axis of the main body (110) and a longitudinal axis of the elongated housing interface (118) can be at an angle that is about or in any range between 75, 80, 85, 90, 95, 100, and 105 degrees.

In some embodiments, the downward-extending filtration housing (120) is downstream of a fluid inlet (150) in the main housing (120). In this way, the water enters the main body (110) and flows into the filtration housing (120). The downward-extending filtration housing (120) is configured to direct the filtered water toward the filter cartridge (130). The downward-extending filtration housing (120) may have an internal diameter of about 4 to about 12 centimeters (e.g., about 5 to 11 centimeters, about 6 to 11 centimeters, about 7 to 11 centimeters, about 8 to 11 centimeters, about 7 to 12 centimeters, or about 8 to 10 centimeters). In some embodiments, the downward-extending filtration housing (120) has an internal diameter of about 9 centimeters. In other embodiments, the downward-extending filtration housing (120) has an internal diameter that is about or in any range between about 4, 5, 6, 7, 8, 9, 10, 11, and 12 centimeters.

The downward-extending filtration housing (120) is also constructed of an elastomeric material and can be identified/optimized as described above. In some embodiments, the main body (110) and the downward-extending filtration housing (120) are constructed from the same elastomeric material. In another embodiment, the main body (110) and the downward-extending filtration housing (120) are constructed from a different elastomeric material. For example, in some embodiments, the downward-extending filtration housing (120) may be more or less flexible than the main body (110). In some embodiments, the downward-extending filtration housing (120) may be less flexible than the main body (110) to facilitate tightly holding the water filtration cartridge (130) in place. The downward-extending filtration housing (120) includes fluid outlet (140) to dispense the filtered water after it flows through the water filtration cartridge (130). The fluid outlet (140) may have an internal diameter of about 4 to about 12 centimeters (e.g., about 5 to 11 centimeters, about 6 to 11 centimeters, about 7 to 11 centimeters, about 8 to 11 centimeters, about 7 to 12 centimeters, or about 8 to 10 centimeters). In some embodiments, the fluid outlet (140) has an internal diameter of about 9 centimeters. In other embodiments, the fluid outlet (140) has an internal diameter that is about or in any range between about 4, 5, 6, 7, 8, 9, 10, 11, and 12 centimeters. In another embodiment, the main body (110) and the downward-extending filtration housing (120) are constructed from a different material. For example, the main body (110) is constructed from an elastomeric material and the downward-extending filtration housing (120) is constructed from a non-elastomeric material or a rigid material. In another embodiment, the main body (110) and/or the downward-extending filtration housing (120) contain a non-elastomeric material or a rigid material insert or overmold that is part of the reversible connection.

The apparatus defines a fluid flow path that passes through the water filtration cartridge (130) and is configured to support water flow rates of higher than the flow rate of a showerhead. For example, in some embodiments, the apparatus supports water flow rates greater than 2.5 gallons per minute and less than 10 gallons per minute. In some embodiments, the apparatus supports water flow rates from about 4 to about 8 gallons per minute. In some embodiments, the apparatus supports water flow rates about or in any range between about 2.5, 3.0, 3.5, 4.0, 4.5, 5.0, 5.5, 6.0, 6.5, 7.0, 7.5, 8.0, 8.5, 9.0, 9.5, 10.0, 10.5, 11.0, 11.5, and 12.0 gallons per minute. For example, the apparatus components, such as the elongated housing interface (118) and the downward-extending filtration housing (120), may have wider than standard plumbing inlets and outlets to accommodate fast water flow and/or high water pressure often found in a bathtub faucet.

As illustrated in FIG. 2, the main body (110) comprising an elongated housing interface (118), can be configured to reversibly connect to a downward-extending filtration housing (120). Such a connection may resist gravitational displacement of the housing or displacement caused by the pressure of the water flow rate of the housing. In addition, such a connection can provide a watertight seal at the junction. In other embodiments, the downward-extending filtration housing (120) is permanently affixed to the main body (110).

The reversible connection between the downward-extending filtration housing (120) and the main body (110) or elongated housing interface (118) may comprise a means for connecting the main body (110) to the downward-extending filtration housing (120). For example, in some embodiments, the main body (110) is reversibly connected to downward-extending filtration housing (120) using a mechanism capable of maintaining structural integrity and preferably watertight performance, of the apparatus during use, even with high water pressures. Exemplary reversible connections include, but are not limited to, snap-fit connection, threaded engagement, interference fits, bayonet-style twist-locks, and magnetic coupling. In some embodiments, the main body (110), elongated housing interface (118), or both, may comprise an additional material to facilitate a functionable connection (e.g., a non-elastomeric material or a rigid material, for example, as an insert or overmold). A non-limiting example of the additional material includes polypropylene.

In one embodiment, the downward-extending filtration housing (120) comprises a circumferential bead (124) proximal to the main body (110) configured to interact with a component in the main body (110) to provide a reversible connection between the downward-extending filtration housing (120) and main body (110). In some embodiments, the circumferential bead is a continuous circumferential bead around the circumference of the downward-extending filtration housing (120) proximal to the main body (110). The downward-extending filtration housing (120) may comprise a region that interacts with the main body (110) that has a smaller diameter than the fluid outlet (140). The smaller-diameter region can tightly fit inside the main body (110), while maintaining position of the water filtration cartridge (130).

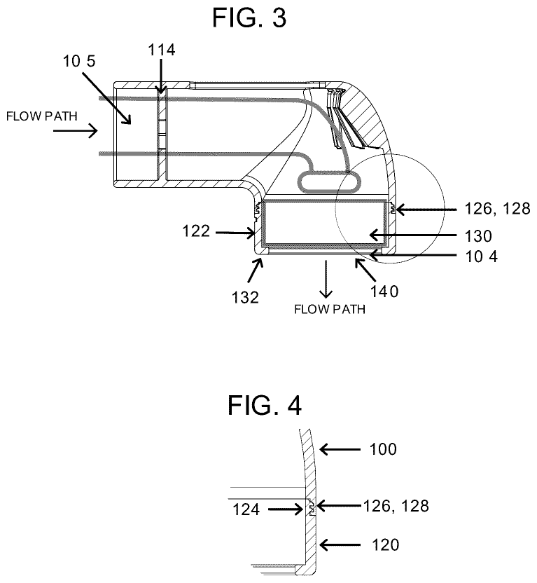

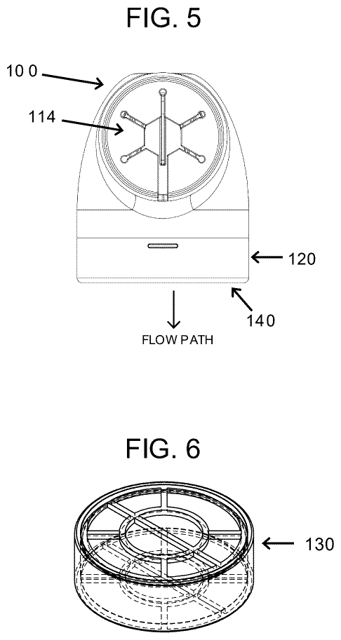

As illustrated in FIG. 3, the downward-extending filtration housing (120) can be dimensioned to elastically deform and engage with one or more (e.g., a pair of) corresponding retention grooves (126, 128) on the inner wall of the main body (110) proximal to the filtration housing (120). Upon insertion of the downward-extending filtration housing (120) into the main body (110), the circumferential bead (124) can compress slightly and then return to its original form, thereby expanding into the corresponding retention grooves (126, 128) and creating a mechanical snap-fit connection, as shown in more detail in FIG. 4. The snap-fit connection may be configured such that user-applied deformation of the surrounding elastomeric wall, achieved by pressing on the outer surface of the main body, temporarily disengages the bead from the retention grooves, thereby allowing tool-free removal of the filter housing. The snap-fit mechanism may be optimized for repeated assembly and disassembly without material degradation.

The downward-extending filtration housing (120) defines an internal cavity (122) configured to house a water filtration cartridge (130). In some embodiments, the water filtration cartridge (130) is a replaceable water filtration cartridge. During use, fluid flows from the spout into the internal cavity, is directed through the cartridge (130) under the force of water pressure and gravity and exits through a filtered outlet aperture (140) located at the distal end of the housing. The cartridge may be retained in position by a circumferential interior lip of the housing (132) and/or compression provided by the downward-extending filtration housing (120). In some embodiments, the water filtration cartridge (130) is a horizontally elongated cylinder. For example, in some embodiments, the water filtration cartridge (130) has a width from about 8 cm to about 10 cm (e.g., 9 cm) and a height of about 1 cm to about 7 cm (e.g., 3 cm). In some embodiments, the water filtration cartridge (130) has a width that is about or in any range between 8, 9 and 10 cm. In some embodiments, the water filtration cartridge (130) has a height that is about or in any range between 1, 2, 3, 4, 5, 6, and 7 cm.

The water filtration cartridge (130) is configured to remove or lower the level of water contaminants, such as chlorine, heavy metals, bacteria, and/or other common waterborne contaminants that can irritate sensitive skin or pose health risks. While the apparatus is not intended to provide potable water filtration, incidental ingestion is considered, particularly in child-use scenarios.

In some embodiments, filtering the water removes any of the specific types of water contaminants described herein, where “removes” refers to the filtered water having a water contaminant lower than the level of detections. In some embodiments, the filtered water has a lower level of one or more water contaminants compared to the unfiltered water. In some embodiments, the filtered water passes one or more NSF/ANSI or EPA standard, such as NSF/ANSI 42, NSF/ANSI 53, NSF/ANSI 401, and NSF/ANSI 177. Any standard and/or appropriate tests can be used to assess water contaminant levels. Exemplary water quality tests are described in Table 1.

TABLE 1
Representative Water Quality Test Methods

| | |
|---|---|
| Contaminant Type | Assay/Test Method |

Particles

| | |
|---|---|
| Turbidity | Nephelometric method, EPA Method 180.1 |
| Total dissolved | Gravimetric method, conductivity meter |
| solids (TDS) | |

Chemicals

| | |
|---|---|
| Chlorine (free | DPD colorimetric test (e.g., SM4500-Cl), test |
| and total) | strips |
| Chloramine | DPD + glycine method, amperometric titration |
| Chloramine | Chloramine |
| Nitrate/Nitrite | EPA Method 353.2 (colorimetric), ion |
| | chromatography |
| VOCs (e.g., | EPA Method 524.2 (Gas Chromatography-Mass |
| chloroform) | Spectrometry) |
| Total Organic | Total Organic Carbon (TOC) |
| Carbon (TOC) | |

Minerals

| | |
|---|---|
| Water hardness | EDTA titration, ISE, ICP-OES |
| (Ca²⁺, Mg²⁺) | |

Metals

| | |
|---|---|
| Lead, copper, | EPA Method 200.8 (ICP-MS), Atomic Absorption |
| mercury | Spectroscopy |

Biological Contaminants

| | |
|---|---|
| Total coliforms & | EPA Method 1604, Colilert ® (enzyme substrate), |
| E. coli | membrane filtration, quantitative PCR (qPCR) |
| Giardia, | EPA Method 1623.1 (immunomagnetic |
| Cryptosporidium | separation + microscopy), qPCR |
| Viruses | Cell culture + PCR, qPCR |

In some embodiments, the filtration is passive gravity-fed water filtration that flows through the water filtration cartridge (130). In other embodiments, the filtration is from a pressurized system that feeds water through the water filtration cartridge (130).

The water filtration cartridge (130) contains one or more filtration medias. Exemplary filtration medias include, but are not limited to, a mechanical filtration media, a chemical filtration media, a specialty media, and a biological media. If multiple filtration medias are included in the water filtration cartridge (130), they may be mixed, layered, sectioned, or a combination thereof. For example, any of the filtration media described can be formulated as granules. In some embodiments, the water filtration granules have a diameter not larger than 4 mm (e.g., between about 1 mm and about 3.9 mm). In some embodiments, the water filtration granules have a diameter that is about or is in any range between 1, 2, 2.5, 3, 3.5, 3.6, 3.7, 3.8, or 3.9 mm. In other embodiments, the water filtration granules have a diameter between about 2 mm and 6 mm (e.g., between about 2 m and about 5 mm, and between about 3 mm and about 5 mm). In some embodiments, the water filtration granules have a diameter that is about or is in any range between 2, 3, 4, 5, and 6 mm.

A mechanical filtration medium, if present, may filter solid particles, such as sand, silt, clay, loose scale, and/or organic matter, from the water based on size exclusion principles. The appropriate type of mechanical filtration depends on the concentration and size of suspended solids and the desired filtration rate. For example, sand media filters offer faster contaminant removal but are less effective for smaller particles. In contrast, fiber or ceramic media have smaller, more uniform pore sizes that more reliably remove fine particles but operate more slowly and require more frequent replacement. Exemplary mechanical filtration media includes, but is not limited to, a polypropylene filter, a polyester filter, a cellulose filter, a ceramic filter, or any combination thereof.

A chemical filtration media, if present, may remove contaminants through adsorption or chemical reactions, targeting dissolved substances, such as those that mechanical filter media may not capture. For example, chemical filtration media may remove chlorine or derivatives thereof such as chloramine, trihalomethanes (e.g., chloroform, bromodichloromethane, dibromochloromethane, and bromoform); byproducts or breakdown products derived from disinfection products such as haloacetic acids (e.g., monochloroacetic acid, dichloroacetic acid, and trichloroacetic acid); volatile organic compounds (VOCs); heavy metals such as lead, copper, or iron; minerals contributing to hard water such as calcium and magnesium; pesticide residues; herbicide residues; pharmaceutical residues; or combinations thereof. Examples of chemical filtration media include, but are not limited to, activated carbon, catalytic carbon, an ion exchange resin, a copper-zinc alloy, ceramic beads, a kinetic degradation fluxion (KDF) media, or any combination thereof. Types of KDF media include KDF-55, which decreases the level of chlorine and water-soluble heavy metals in the water; KDF-85, which decreases the level of iron and hydrogen sulfide in the water; KDF-F, which is a fine mesh often combined with carbon-based filters; or KDF-C, which is a course mesh that decreases the level of chloring and water-soluble heavy metals.

A specialty filtration media, if present, may include blends of filtration media, and remove for example, per- and polyfluoroalkyl substances (PFAS). Examples of specialty filtration media include, but is not limited to, a mixed bed resin, alumina, birm, greensand, an anion exchange resin, a zeolite, or any combination thereof.

A biological filtration media, if present, may remove biological contaminants that may not be removed by the mechanical filtration media. For example, biological filtration media may remove bacteria, such as Escherichia coli or Salmonella; viruses, such as norovirus or hepatitis virus A; protozoa, such as Giardia or Cryptosporidium; fungal or algal spores, helminths; or combinations thereof. Examples of biological filtration media include, but are not limited to, a silver-impregnated carbon, a silver-impregnated ceramic, a copper-zinc alloy, or any combination thereof. The type of biological contaminant removed by the biological filtration media can be tailored by using specific biological filtration units. In some embodiments, for example, a biological filtration medium can filter out biological contaminants using size exclusion of a size smaller than the mechanical filtration media, if present. Such biological filtration media that work based on size exclusion include, but are not limited, to microporous filters, which are often ceramic or hollow-fiber membranes, ultrafiltration filters, and nanofiltration filters.

Water pressure in a residential home is between about 40 pounds per square inch (psi) and about 80 psi. Some embodiments of the apparatus may be configured to stay connected to the faucet and effectively filter water at up to about 90 psi. Other embodiments of the apparatus may be configured to stay connected to the faucet and effectively filter water at water pressures between about 40 psi and about 90 psi (e.g., between about 50 psi and about 70 psi, between about 45 psi and about 65 psi, or between about 40 psi and about 60 psi). In some embodiments, the apparatus may be configured to stay connected to the faucet and effectively filter water at a water pressure that is about or in any range between 40, 45, 50, 55, 60, 65, 70, 75, 80, 85, and 90 psi. Therefore the main body (110) may be configured to remain connected to the faucet between such water pressure ranges, the downward-extending filtration housing (120) is configured to remain connected to the main body (110) between such water pressure ranges, and/or the water filtration cartridge (130) is configured to effectively treat water between such water pressure ranges.

Determining if an apparatus can withstand a high flow rate can include using a variety of tests, including a burst pressure or hydrostatic pressure test. Hydrostatic and burst pressure tests evaluate the strength and pressure tolerance of fluid-handling devices like fittings and filters. For example, a burst pressure test may attach any of the apparatuses described herein to a faucet and apply pressure that is continuous and rapidly increased to identify the maximum pressure at which the apparatus fails (bursts), or as is the case for apparatuses disclosed herein, detaches from the faucet or does not adequately provide filtered water. A hydrostatic pressure test assess a material's ability to withstand continuous internal water pressure over time and can include filling any of the apparatuses described herein with a certain amount of water to achieve a specified internal pressure, and holding the specified internal pressure at for a prolonged period of time (e.g., 24 hours, 48 hours, or even 1000 hours, or until failure). In some embodiments, a hydrostatic pressure test holding the specified internal pressure at for a prolonged period of time that is about or is any range between 24, 48, 72, 100, 200, 300, 400, 500, 600, 700, 800, 900, or 1000 hours. In other embodiments, a hydrostatic pressure test holds an apparatus at the specified internal pressure until failure of the apparatus. During a hydrostatic pressure test, multiple experiments are generally performed to identify the pressure at which the apparatus does not fail, and all experiments are completed at a controlled temperature (e.g., at a temperature that approximates the temperature of water exiting a faucet or is slightly higher, such as 130° F. or 140° F., or 150° F.). In some embodiments, the controlled temperature is about or is any range between 120° F., 125° F., 130° F., 135° F., 140° F., 145° F., 150° F., 155° F., and 160° F. Two ASTM standards used for this are described in ASTM D1598 (burse pressure test) and ASTM D15199 (hydrostatic pressure test), respectively. Any of these tests can be performed on an apparatus with or without the water filtration cartridge (130) attached to the apparatus.

Also disclosed herein are methods of filtering water through any of the faucet-mounted water filtration and safety apparatus described herein. The method can include mounting the apparatus on a faucet, directing incoming water through the fluid inlet (150), and filtering the incoming water through the water filtration cartridge, thereby generating filtered water and dispensing the filtered water through a fluid outlet. Another method can include mounting the apparatus on a faucet, removably coupling a downward-extending filtration housing to the elastomeric main body, directing incoming water through the fluid inlet (150), and filtering the incoming water through the water filtration cartridge, thereby generating filtered water and dispensing the filtered water through a fluid outlet. In any of the methods described herein, the filtered water may have a lower level or concentration of one or more undesired contaminants compared to the incoming water. In some embodiments, removably coupling a downward-extending filtration housing to the elastomeric main body is performed such that the downward-extending filtration housing is positioned downstream from the fluid inlet (150), a replaceable water filtration cartridge is disposed within the downward-extending filtration housing, and/or the downward-extending filtration housing is removably coupled to the elastomeric main body by a releasable attachment mechanism configured for tool-free removal.

Also described herein are methods of making any of the apparatuses described herein or any of the components of the apparatuses described herein. In some embodiments, the main body (110), downward-extending filter housing (120), and water filter cartridge (130) are plastic injection molded parts (e.g., silicone injection molded parts). Injection molding is a manufacturing process in which a thermoplastic or thermoset material is heated until molten and injected into a mold cavity. The molten material conforms to the shape of the mold and solidifies upon cooling, forming a part having the desired geometry. After molding, the part may undergo post-processing steps such as trimming, deflashing, ultrasonic welding, heat staking, surface texturing, or painting/coating, as required. Molded components may be joined using mechanical fasteners, adhesives, snap-fits, or other conventional assembly techniques. The water filtration cartridge can be assembled from components including, but not limited to, nylon mesh, reticulated foam, and media-fill granules.

Also described herein are kits comprising the main body (110) configured to fit over a faucet or spout (105) and a downward-extending filtration housing (120) that defines an internal cavity (122) into which a water filter cartridge can be positioned. The downward-extending filtration housing (120) can be reversibly coupled to the main body in the kit, or can be separated, but configured to be reversibly coupled upon installation by a user. In some embodiments, the kit also includes a water filtration cartridge. Instructions for operation can also be included in the kit, or a QR code or website address that are linked to instructions for operation.

What is claimed is:

1. A faucet-mounted water filtration and safety apparatus comprising:
an elastomeric main body configured to fit over a faucet;
a fluid inlet with a diameter dimensioned for high water flow rate between about 40 psi to about 90 psi, optionally wherein the fluid inlet has a diameter from about 80 mm to about 100 mm;
a downward-extending filtration housing removably connected to the elastomeric main body and positioned downstream from the fluid inlet;
a replaceable water filtration cartridge disposed within the filtration housing; and
a fluid outlet configured to dispense filtered water;
wherein the filtration housing is coupled to the main body by a releasable attachment mechanism configured for tool-free removal; and
wherein each of the downward-extending filtration housing and the fluid outlet has an internal diameter of about 4 to about 12 centimeters.

2. The apparatus of claim 1, wherein the releasable attachment mechanism comprises a snap-fit connection including a circumferential bead and one or more corresponding grooves.

3. The apparatus of claim 1, wherein the releasable attachment mechanism comprises a threaded engagement or a bayonet-style twist lock.

4. The apparatus of claim 1, wherein the releasable attachment mechanism comprises a magnetic coupling.

5. The apparatus of claim 1, wherein the apparatus defines a fluid flow path and the fluid flow path passes through the replaceable water filtration cartridge that is configured to support water flow rates of about 4 to about 8 gallons per minute.

6. The apparatus of claim 1, wherein the elastomeric main body includes a diverter valve aperture to accommodate diverter-equipped spouts.

7. The apparatus of claim 1, wherein the replaceable water filtration cartridge comprises a mechanical filtration media, a chemical filtration media, a specialty filtration media, a biological filtration media, or any combination thereof, and optionally wherein:
the mechanical filtration media is a polypropylene filter, a polyester filter, a cellulose filter, a ceramic filter, or any combination thereof;
the chemical filtration media is activated carbon, catalytic carbon, an ion exchange resin, a copper-zinc alloy, ceramic beads, or any combination thereof;
the specialty filtration media is a mixed bed resin, alumina, birm, greensand, an anion exchange resin, a zeolite, or any combination thereof; and/or
the biological filtration media is a silver-impregnated carbon, a silver-impregnated ceramic, a copper-zinc alloy, or any combination thereof.

8. The apparatus of claim 1, wherein the faucet is a bathtub spout or a sink spout.

9. A method of filtering water through a faucet-mounted water filtration and safety apparatus comprising:
mounting the apparatus on a faucet, the apparatus comprising:
an elastomeric main body; and
a fluid inlet with a diameter dimensioned for high water flow rate between about 40 psi to about 90 psi, optionally wherein the fluid inlet has a diameter from about 80 mm to about 100 mm;
removably coupling a downward-extending filtration housing to the elastomeric main body such that the downward-extending filtration housing is positioned downstream from the fluid inlet, a replaceable water filtration cartridge is disposed within the downward-extending filtration housing, and the downward-extending filtration housing is removably coupled to the elastomeric main body by a releasable attachment mechanism configured for tool-free removal; and
directing incoming water through the fluid inlet;
filtering the incoming water through the replaceable water filtration cartridge, thereby generating filtered water; and
dispensing the filtered water through a fluid outlet, the filtered water including a lower concentration of one or more water contaminants compared to the incoming water;
wherein each of the downward-extending filtration housing and the fluid outlet has an internal diameter of about 4 to about 12 centimeters.

10. The method of claim 9, wherein the releasable attachment mechanism comprises a snap-fit connection including a circumferential bead and one or more corresponding grooves.

11. The method of claim 9, wherein the releasable attachment mechanism comprises a threaded engagement.

12. The method of claim 9, wherein the releasable attachment mechanism comprises a magnetic coupling.

13. The method of claim 9, wherein the apparatus defines a fluid flow path and the fluid flow path passes through the replaceable water filtration cartridge that is configured to support water flow rates of about 4 to about 8 gallons per minute.

14. The method of claim 9, wherein the elastomeric main body includes a diverter valve aperture to accommodate diverter-equipped spouts.

15. The method of claim 9, wherein the replaceable water filtration cartridge comprises a mechanical filtration media, a chemical filtration media, a specialty media, a biological media, or any combination thereof, and optionally wherein:
the mechanical filtration media is a polypropylene filter, a polyester filter, a cellulose filter, a ceramic filter, or any combination thereof;
the chemical filtration media is activated carbon, catalytic carbon, an ion exchange resin, a copper-zinc alloy, ceramic beads, or any combination thereof;
the specialty filtration media is a mixed bed resin, alumina, birm, greensand, an anion exchange resin, a zeolite, or any combination thereof; and/or
the biological filtration media is a silver-impregnated carbon, a silver-impregnated ceramic, a copper-zinc alloy, or any combination thereof.

16. The method of claim 9, wherein the faucet is a bathtub spout or a sink spout.

17. A faucet-mounted water filtration and safety apparatus comprising:
an elastomeric main body configured to fit over a faucet;
a fluid inlet with a diameter dimensioned for high water flow rate between about 40 psi to about 90 psi, optionally wherein the fluid inlet has a diameter from about 80 mm to about 100 mm;
a downward-extending filtration housing connected to the elastomeric main body and positioned downstream from the fluid inlet;
a replaceable water filtration cartridge disposed within the filtration housing; and
a fluid outlet configured to dispense filtered water; and
wherein each of the downward-extending filtration housing and the fluid outlet has an internal diameter of about 4 to about 12 centimeters.

18. The apparatus of claim 17, wherein the releasable attachment mechanism comprises a snap-fit connection including a circumferential bead and one or more corresponding grooves.

19. The apparatus of claim 17, wherein the apparatus defines a fluid flow path and the fluid flow path passes through the replaceable water filtration cartridge that is configured to support water flow rates of about 4 to about 8 gallons per minute.

20. A method of filtering water through the faucet-mounted water filtration and safety apparatus of claim 17 comprising:
mounting the apparatus of claim 17 on a faucet,
directing incoming water through the fluid inlet;
filtering the incoming water through the replaceable water filtration cartridge, thereby generating filtered water; and
dispensing the filtered water through a fluid outlet, the filtered water including a lower concentration of one or more water contaminants compared to the incoming water.
